(19) United States
(12) Patent Application Publication
(10) Pub. No.: US 2013/0129398 A1
(43) Pub. Date: May 23, 2013

(54) KEYPAD OVERLAY DEVICE FOR TOUCH SENSITIVE KEYPADS

(71) Applicant: John Albert KOEPKE, Sun City West, AZ (US)

(72) Inventor: John Albert KOEPKE, Sun City West, AZ (US)

(21) Appl. No.: 13/676,223

(22) Filed: Nov. 14, 2012

Related U.S. Application Data
(60) Provisional application No. 61/561,831, filed on Nov. 19, 2011.

(51) Int. Cl. H01H 13/85

(52) U.S. Cl. CPC H01H 13/85
USPC 400/491

(57) ABSTRACT

A keypad overlay device adapted for placement on top of a touch-sensitive, digital keypad of an electronic device is shown. The keypad overlay device includes a plurality of open key cells, each key cell having an open top, a bottom membrane defining an opening therethrough, a side wall member defining an opening therein, and an open, force sensitive membrane disposed between the opening of the bottom membrane and the side wall member. The open, force sensitive membrane being adapted to during use, provide a resistance to the fingers of the operator. Each open key cell may be placed on top of the corresponding key of the digital keypad and the key icons of the digital keypad are visible through the open key cells of the overlay device.

### TECHNICAL FIELD

The disclosed subject matter relates generally to keypads and keypad accessories for electronic devices, and more particularly to keypad accessories for touch-sensitive digital keypads used in electronic devices.

### BACKGROUND

Electronic devices such as mobile communication devices, hand-held computers, calculators, and the like, often use a touch-sensitive digital keypad for entry of data and commands. The digital keypad may be shown on a touch-sensitive display screen that is used to display an output from the electronic device and to receive an input from a user. The touch-sensitive digital keypads generally use electronic technology that responds to the human finger making physical contact. Digital keypads respond to a human finger making physical contact with the touch-sensitive keypad on the display screen. Sensing the light touch of the human finger initiates an electronic signal indicating that a change in state has occurred.

The keypad icons on the digital keypad are generally small and placed close to each other. A user may often strike one or more keypad icons erroneously when attempting to engage a particular key icon. The user frequently makes errors due to inaccurate key touches and requires more time for typing on the digital keypad. U.S. Pat. No. 5,572,573 issued Nov. 5, 1996 appears to teach a flat cover pad for a digital device, such as, a telephone or smart phone. Even though the flat cover has openings that line up the respective key icons thereon, it does not have individual open key cell members that function to give the respective keys a ‘feel’ such as that for a regular typewriter, or such. Conventional digital keypads do not provide a level of comfort beyond the required tapping of the finger onto the top surface of the keypad. This is uncomfortable to the user and reduces typing speed. There is a need to improve typing speed and comfort level of users of digital keypads of touchscreen devices. U.S. Pat. No. 8,206,047 issued Jun. 26, 2012 teaches an overlay device for use on devices having touch sensitive keyboards, it clearly does not teach the use of an open key cell member to provide sensitivity to the user. In fact, it teaches away from an open cell arrangement by requiring the use of a thin membrane between the user's finger and the actual surface of the touch screen on the digital device. There is also a need to protect and store the keypad overlay device when it is not in use.

### SUMMARY

For purposes of summarizing, certain aspects, advantages, and novel features being described herein. It is to be understood that not all such advantages may be achieved in accordance with any one particular embodiment. Thus the disclosed subject matter may be embodied or carried out in a manner that achieves or optimizes one advantage or group of advantages without achieving all advantages as may be taught or suggested herein.

In accordance with one embodiment, a keypad overlay device adapted for placement on top of a touch-sensitive, digital keypad of known electronic devices is disclosed. The keypad overlay device includes a plurality of open key cells connected to a bottom membrane and, when in use, is adapted to be located generally on top of corresponding key icons of the known electronic device having a touch-sensitive, digital keypad. Each of the open key cells has an open top surface, an open bottom surface defined in the bottom membrane, a side wall connected to the top surface and extends therefrom to define an open space of a predetermined cross-sectional size and shape, and an open, force sensitive membrane of a predetermined cross-sectional size and shape connected between the side wall and the open bottom surface defined by the bottom membrane. During use, the keypad overlay device is disposed over the touch-sensitive, digital keypad of the known electronic device so that the key icons on the digital keypad are visible through the open key cells and have a touch sensitive feel upon depression of the respective open key cells. Furthermore, during use, the keypad overlay device may be secured to the known electronic device. When not in use, the keypad overlay device may be stored on the backside of the known electronic device.

Other objects, features, and advantages of the present design will become more apparent from the following detailed description of the subject embodiment and certain modification thereof when taken together with the accompanying drawings. The above-disclosed embodiment in addition to certain alternatives is provided in further detail below with reference to the attached drawings. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below:

FIG. 1 illustrates an isometric view of a keypad overlay device adapted for placement on top of a touch-sensitive, digital keypad of an electronic device;

FIG. 2 illustrates a top view of the keypad overlay device illustrated in FIG. 1;

FIG. 3 is a sectional view taken along the line 1-1 of FIG. 2;

FIG. 4 is a sectional view taken along the line 2-2 of FIG. 2;

FIG. 5 is an enlarged sectional view taken along the line 3-3 of FIG. 2;

FIG. 6 is a bottom view of FIG. 2.

### DETAILED DESCRIPTION OF EXAMPLE EMBODIMENTS

In the following paragraphs, numerous specific details are set forth to provide a thorough description of an exemplary embodiment. Other embodiments may be practiced without these specific details or with some variations in detail. In some instances, certain features are described in less detail so as not to obscure other aspects. The level of detail associated with each of the elements or features should not be construed to qualify the novelty or importance of one feature over others.

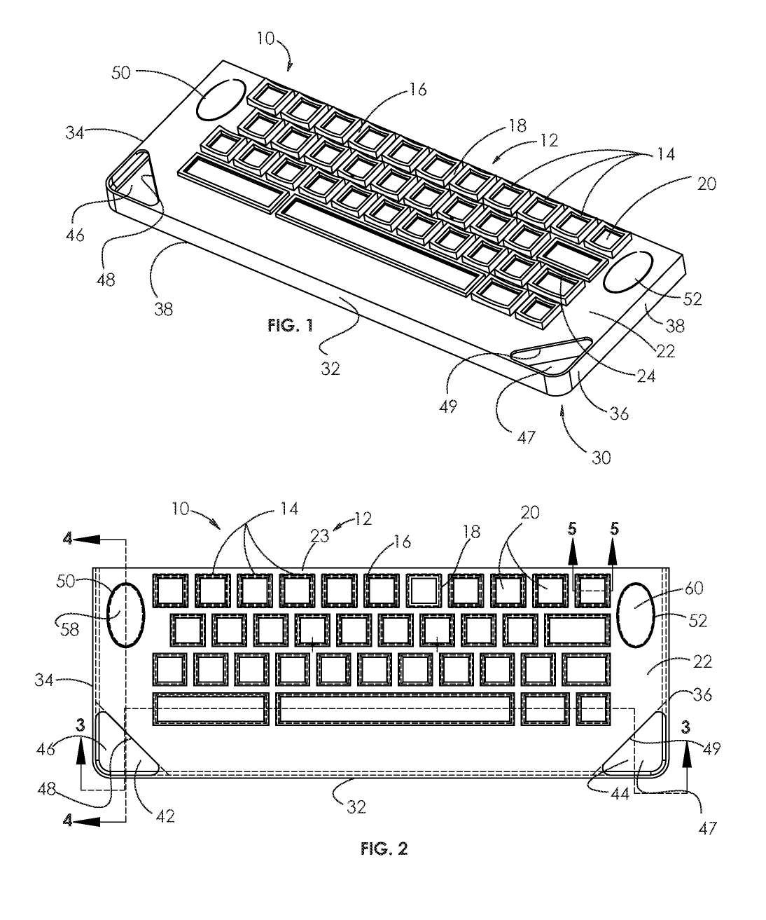

FIG. 1 illustrates an isometric view of a keypad overlay device 10 adapted for placement on top of a known electronic device (not shown) having a touch-sensitive, digital keypad touch screen. The keypad overlay device 10 includes a plurality of open key cells 12. Each open key cell 14 of the plurality of open key cells 12 has a top surface 16, a side wall 18 connected to the top surface 16 and extends therefrom to define an open space 20 in the vertical wall 18. It is recognized that the side wall 18 could have various cross-sectional configurations, such as, for example, cylindrical, square, rectangular, oblong, etc without departing from the essence of the subject invention. As shown in the drawings, a combination of square and rectangular side wall 18 are used.

A bottom membrane 22 is provided to interconnect each of the open key cells 14 and has a rear end surface 23. Respective open, force sensitive membranes 24 connect the respective side wall 14 of each of the open key cells 14 to the bottom membrane 22. Each open key cell 14 is connected to the bottom membrane 22 through the respective open, force sensitive membranes 24 and extends outward therefrom. Additional details with respect to the open, force sensitive membranes 24 will be set forth hereafter with respect to FIG. 5. During operation, the keypad overlay device 10 is placed on top of the touch-sensitive, digital keypad touch screen of the known device (not shown).

In one implementation, the touch screen of known electronic devices (not shown) is used for entry of data and commands. The keypad overlay device 10 may be adapted, with minor modifications, for use on any keypad of a touch screen electronic device including, but not limited to a tablet computer (e.g., iPad), a touch screen portable electronic device, a touch screen mobile communication device (e.g., iPhone), a touch screen hand-held computer, a touch screen calculator, a touch screen notebook, a touch screen gaming device, etc.

The touch-sensitive, digital keypad of the well known electronic devices generally includes various key icons shown on a surface of the digital keypad. In the subject embodiment, the known key icons may be used to identify, such as, for example, letters, numbers, symbols, and functions. In use, each open key cell 14 of the plurality of open key cells 12 on the keypad overlay device 10 is positioned to register on top of a key icon of a corresponding key of the digital keypad of the known electronic device. The key icons of the digital keypad of the electronic device are visible through the respective open key cells 14 of the keypad overlay device 10. Each open key cell 14 directly interfaces with the corresponding key icon on the digital keypad of the electronic device to permit a human finger to come into direct contact with the corresponding key icon of the digital keypad of the electronic device in a known manner via the hollow space 20. The subject keypad overlay device 10 serves to both align the human finger to touch the proper key icon on the electronic device and ensure that only one key icon is depressed with the single touch of the human finger.

Referring to FIG. 2, a top view of the keypad overlay device 10, in accordance with the subject embodiment, is disclosed. In the subject embodiment, the plurality of open key cells 12 of the keypad overlay device 10 is arranged in the manner of a “QWERTY” keyboard. The keypad overlay device 10 may also include a numerical entry pad or other known arrangements. The subject embodiment is not limited to any particular arrangement of the plurality of open key cells 12, but contemplates all possible arrangements without departing from the scope of the following claims and equivalents thereof.

The top surface 16 of the respective open key cells 14 of the plurality of open key cells 12 generally matches a curvature of the human finger so as to provide comfort to the user. The location of the respective key cells 14 may be identified by direct observation of the key icons on the electronic device through the open space 20 thereof. In the subject embodiment, the keypad overlay device 10 is formed from a monolithic elastomeric material, which flexibly conforms to curved and irregular surfaces and underlying structural elements.

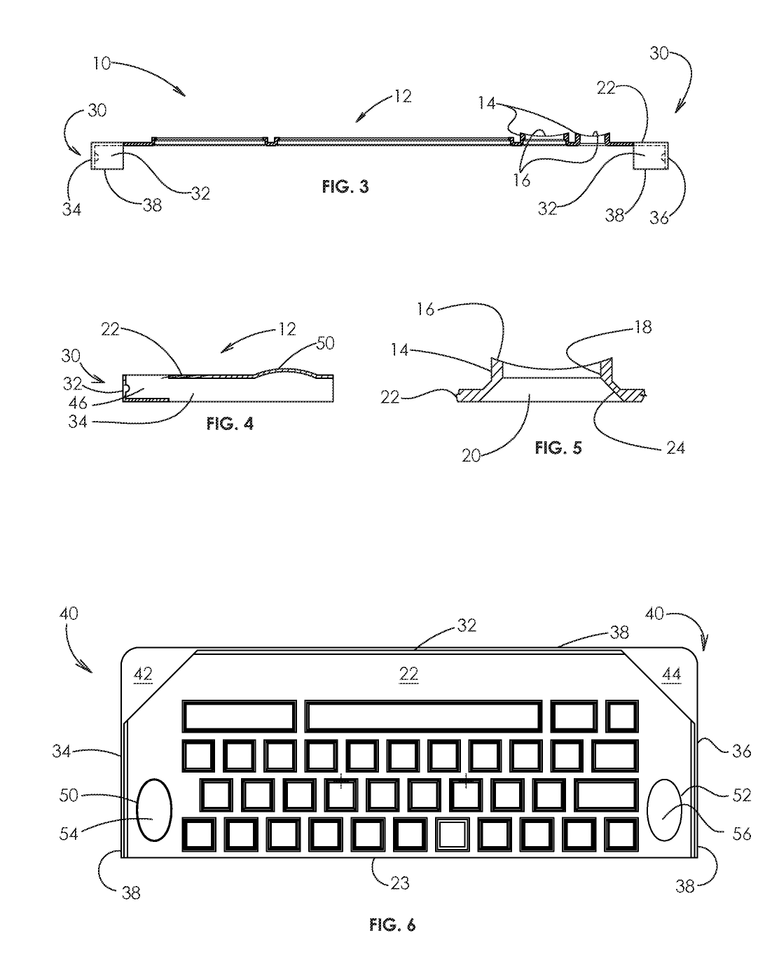

Referring to FIGS. 3&4 and in cooperation with FIGS. 1&2, sectional side views taken along the respective sectional lines 1-1 & 2-2 of FIG. 2 illustrate, in greater detail, the perimeter of the keypad overlay device 10. The keypad overlay device 10 includes an integral skirt 30 connected to the bottom membrane 22. The integral skirt 30 includes a front side 32 connected to the front of the bottom membrane 22 and extends therefrom in a direction opposite to the direction of the plurality of open key cells 12. The integral skirt 30 further includes first and second opposed sides 34,36 connected to the bottom membrane 22 and extending therefrom in the same direction as the front side 32. The first and second sides 34,36 are connected to the front side 32 at each end thereof. The integral skirt 30 extends from the bottom membrane 22 for a predetermined distance to define a bottom surface 38

Referring to FIG. 5, a sectional side view of FIG. 2 taken along the line 3-3, in accordance with the subject embodiment, illustrates in greater detail, one of the open key cells 14 of the plurality of open key cells 12. The open top surface 16 coincides with the open space 20 within the side wall 18 of the open key cell 14. The open space 20 has a predetermined cross-sectional size and shape. The open, force sensitive membrane 24 has a predetermined cross-sectional size and shape wherein the size of the opening of the open, force sensitive membrane is greater than the size of the open space within the side wall 18 of the open key cell 14. It is recognized that the cross-sectional area of the open, force sensitive membrane 24 could progressively increase in cross-sectional area from the connection thereof with the open space 20 in the side wall 18 until it connects with and exits from the bottom membrane 22. It is also recognized, like that of the side wall 18, that other forms could be used without departing from the essence of the subject invention. Such as square or rectangular, as taught in the drawings. The size and shape of the open, force sensitive membrane 24 acts, during use, to provide a resistive force or ‘feel’ to the user prior to the user's finger collapsing the open key cell 14 and contacting the touch, sensitive key icons of the known electronic device This provides a design controlled ‘force point’ location for the respective open key cells 14 to collapse and achieve a sudden, change in depression force and further travel until the human finger makes direct, physical contact with the associated key icon of the digital keypad of the known electronic device. The change in force combined with the additional travel that is experienced by the human finger provides tactile feedback that an event has occurred.

Referring to FIG. 6, in cooperation with FIGS. 1&2, a securing mechanism 40 is provided. The securing mechanism 40 includes first and second strap members 42,44. The first strap member 42 is connected to a portion of the first opposed side 34 adjacent to the bottom surface 38 thereof and to an end portion of the front side 30 adjacent to the bottom surface 38 thereof. The second strap member 42 is connected to a portion of the second opposed side 34 adjacent to the bottom surface 38 thereof and to another end portion of the front side 30 adjacent to the bottom surface 38 thereof. A first space 46 (best seen in FIG. 1) is defined between the first strap member 42 and the bottom membrane 22 and a second space 47 (best seen in FIG. 1) is defined between the second strap 44 and the bottom membrane 22. The first and second spaces 46,47 are operative, in use, to receive the front corners of the known electronic device and secure the keypad overly device 10 thereto during use. For the ease of mounting the keyed overlay device 10 on the known electronic device, during use, first and second openings 48,49 are defined in the bottom membrane 22. The first opening 48 is defined in the bottom membrane 22 directly above the first strap 42 and the second opening 49 is defined in the bottom membrane 22 directly above the second strap 44. The first and second openings 47,48 has a shape generally the same as that of the first and second straps 42,44.

The securing mechanism 40 also includes first and second suction cup devices 50,52. The first suction cup device 50 is located on the bottom membrane 22 spaced from the first opposed side 34 near the rear end surface 23 thereof. The second suction cup device 52 is located on the bottom membrane 22 spaced from the second opposed side 36 near the rear end surface 23 thereof. The first and second suction cup devices 50,52 are defined in the bottom membrane 22 by forming respective depressions 54,56 in the bottom membrane 22 from the side thereof opposite to the side containing the plurality of open key cells 12. The respective depressions 54,56 inherently form raised surfaces 58,60 on the opposite side thereof.

During use, the front corners of the known electronic device are disposed in the first and second spaces 46,47 defined in the keypad overlay device 10 until the front of the electronic device contacts the front side 32 of the keypad overlay device 10. Once contact has been made, the remainder of the keypad overlay device 10 is laid flat onto the top surface of the electronic device. The suction cup devices 50,52 are activated by pressing down on the raised surfaces 58,60, thus forcing air from the space of the depressions 54,56 between the bottom membrane 22 and the top surface of the known electronic device. Removal of the air from the depressions 54,56 results in a negative air pressure being developed therein to hold the bottom membrane 22 of the keypad overlay device 10 to the surface of the known electronic device.

When the keypad overlay device 10 is not it use, it can be mounted to the backside of the known electronic device using the same steps used when mounting the keypad overlay device 10 to the front thereof.

### INDUSTRIAL APPLICABILITY

It is desirable to use known electronic devices to input command data into the electronic devices and to generate desirable output on a screen or the like. Since most input commands require large amounts of keyed input and the key icons on the known electronic devices are relatively close together, it is desirable to have an overlay device to aid in more accurately and comfortably inputting the keyed data. The keyed overlay device 10, of the subject design may be used to aid the user in inputting the keyed data. As an example, the keyed overlay device 10 will be used on a known electronic device, such as, an iPad. The user slides the front corners of the known electronic device into the first and second spaces 46,47 of the keypad overlay device 10 while being sure to have the plurality of open key cells 12 facing the user. The keyed overlay device 10 continues to move until the front edge of the known electronic device contacts the front side 32 of the keypad overlay device 10. At this point, the bottom membrane 22 along with the plurality of open key cells 12 is positioned in a flat manner on top of the known electronic device. To further ensure that the keyed overlay device 10 is secured to the known electronic device, the user depresses the respective raised surfaces 58,60 of the first and second suction cups 50,52 to establish a holding suction force between the bottom membrane 22 of the keyed overlay device 10 and the known electronic device. Once the keyed overlay device 10 is secured to the known electronic device, the user may begin to perform his/her task.

Since, in the subject example, the known electronic device has a typical key icon legend displayed on the electronic screen thereof, the user places his/her fingers in the normal typing position on the appropriate ones of the open key cells 14 of the plurality of open key cells 12. As the user applies a force to one or more of the open key cells 14, a resistance is felt by the user. As the force is increased and reaches a predetermined level, suddenly the one or more of the open key cells 14 collapses and the finger(s) of the user contacts the surface of the electronic device to deliver the desire command data to the known electronic device. The resistance force felt by the user is provided by the open, force sensitive membrane 24 that is disposed between the side wall member 18 and the bottom membrane 22. The collapsing of the open, force sensitive membrane 24 permits the top surface 16 along with the side wall member 18 to move toward the bottom membrane 22. At or near the end of the movement, the user's finger makes direct contact with the surface of the known electronic device thus delivering the input command thereto. Once the user removes the force applied to respective ones of the plurality of open key cells 12, the top surface 16 along, with the side wall member 18 of the respective ones return to their initial positions.

Once the user has completed the desired task, he/she may remove the keyed overlay device 10 for storage. The keyed overlay device 10 may be stored on the back of the known electronic device. Storage of the keyed overlay device 10 is easily accomplished by turning the known electronic device over and mounting the keyed overlay device 10 to the back of the known electronic device. Use the same mounting procedure for mounting the keyed overlay device 10 on the back as was used for mounting it on the front.

The claimed subject matter has been provided herein with reference to one or more features or embodiments. Those skilled in the art will recognize and appreciate that, despite the detailed nature of the exemplary embodiment provided herein; changes and modifications may be applied to said embodiment without limiting or departing from the generally intended scope. These and various other adaptations and combinations of the embodiment provided here are within the scope of the disclosed subject matter as defined by the claims and their full set of equivalents.

What is claimed is:

1. A keypad overlay device adapted, in use, for placement on top of a touch-sensitive, digital keypad of an electronic device, the overlay device comprising:
a plurality of open key cells connected to a bottom membrane, each open key cell of the plurality of open key cells, when in use, is adapted to be located generally on top of corresponding keys of the known electronic devices having touch-sensitive, digital positions, each open key cell having an open top surface, an open bottom surface defined in the bottom membrane, a side wall member connected to the open top surface and extending therefrom to define an open space of a predetermined cross-sectional size and shape, and an open, force sensitive membrane of a predetermined cross-sectional size and shape connected between the side wall member and the open bottom surface defined by the bottom membrane.

2. The overlay device of claim 1, wherein the predetermined cross-sectional size of the open space defined by the side wall member is smaller than the cross-sectional size of the opening in defined by the force sensitive membrane.

3. The overlay device of claim 1, wherein the plurality of open key cells are joined together by the bottom membrane like a monolith.

4. The overlay device of claim 1, wherein each one of the plurality of the key cells has a cylindrical top surface adapted to match the curvature of a human finger.

5. The overlay device of claim 1, having an integral skirt formed by a front side and first and second opposed sides, each of the first, second and third sides are connected to and extend from the bottom membrane.

6. The overlay device of claim 5, wherein each of the first, second and third sides extend from the bottom membrane for a predetermined distance to define a bottom surface thereon.

7. The overlay device of claim 6, having a securing mechanism attached to the bottom surface of the first, second, and third sides,

8. The overlay device of claim 7, wherein the securing mechanism has a first strap member connected between the bottom surfaces of the first and second sides.

9. The overlay device of claim 8, wherein the securing mechanism has a second strap member connected between the bottom surfaces of the first and third sides.

10. The overlay device of claim 1, The overlay device of claim 7, wherein bottom membrane has a rear end surface and the securing mechanism includes first and second suction cups integral formed on the bottom membrane and disposed at a location spaced from the respective second and third sides and the rear end surface of the bottom membrane.

11. The overlay device of claim 1, wherein the side wall member has four side walls interconnected together to form a four sided figure.

12. The overlay device of claim 1, wherein the open, force sensitive membrane has four side walls interconnected together to form a four sided figure.

13. The overlay device of claim 1, wherein the side wall member and the open, force sensitive membrane each has four side walls interconnected together and extends from the open top surface to the open bottom surface defined in the bottom membrane.

14. The overlay device of claim 1, wherein each open key cell is adapted to establish, during use, clear visibility between the user and the top of the touch-sensitive, digital keypad of the electronic device without parallax error.
